(19) United States
(12) Patent Application Publication
(10) Pub. No.: US 2014/0338757 A1
(43) Pub. Date: Nov. 20, 2014

(54) Emergency Shut Off Mechanism

(71) Applicant: Loren Van Wyk, Pella, IA (US)

(72) Inventor: Loren Van Wyk, Pella, IA (US)

(21) Appl. No.: 13/897,950

(22) Filed: May 20, 2013

(51) Int. Cl. F16K 17/38

(52) U.S. Cl. CPC F16K 17/383
USPC 137/75

(57) ABSTRACT

Disclosed is an actuator that may include a handle, a telescoping assembly connected to the handle, and a cable. In example embodiments, the telescoping assembly may include a sleeve, a sliding member configured to move along the sleeve, and a movable stop. In example embodiments, when the movable stop is in a first position the movable stop may prevent the sliding member from moving beyond a first point in the sleeve and when the movable stop is in a second position the movable stop may allow the sliding member to move beyond the first point in the sleeve. In example embodiments, the cable may be attached to the telescoping assembly and the cable may be configured to operatively move the movable stop.

### BACKGROUND

1. Field

Example embodiments are directed to an actuator. In example embodiments the actuator may be used to actuate a valve and may be used as an emergency shut off mechanism.

2. Description of the Related Art

Valves are engineered devices that allow fluid to flow from one location to another. Valves are used in various industries ranging from the power industry, where they are used to regulate steam flowing through pipes, to the automotive industry where that are used to control a flow of fuel flowing through a system.

In the conventional art, some valves are designed for manual operation. These valves often include handles to open or close the valve. In the case of an accident valves may have to be closed quickly. Under these circumstances, a user may have to run to the handle to turn off the valve.

### SUMMARY

Example embodiments are directed to an actuator. In example embodiments the actuator may be used to actuate a valve and may be used as an emergency shut off mechanism.

In accordance with example embodiments, an actuator may include a handle, a telescoping assembly connected to the handle, and a cable. In example embodiments, the telescoping assembly may include a sleeve, a sliding member configured to move along the sleeve, and a movable stop. In example embodiments, when the movable stop is in a first position the movable stop may prevent the sliding member from moving beyond a first point in the sleeve and when the movable stop is in a second position the movable stop may allow the sliding member to move beyond the first point in the sleeve. In example embodiments, the cable may be attached to the telescoping assembly and the cable may be configured to operatively move the movable stop.

### BRIEF DESCRIPTION OF THE DRAWINGS

Example embodiments are described in detail below with reference to the attached drawing figures, wherein:

FIGS. 1A-1B are a views of a valve in accordance with example embodiments;

FIG. 2 is a view of an actuator in accordance with example embodiments;

FIG. 3A is a view of a handle in accordance with example embodiments;

FIG. 3B is an exploded view of the handle in accordance with example embodiments;

FIGS. 4A-4J are views of a telescoping assembly in accordance with example embodiments and parts thereof;

FIG. 5 is a view of a link in accordance with example embodiments;

FIGS. 6A-6B illustrate a close up view of a cable attaching to a platform in accordance with example embodiments;

FIGS. 7A-7D illustrates biasing members in accordance with example embodiments;

FIGS. 8A-8C illustrate various operating configurations of the actuator in accordance with example embodiments; and

FIG. 9 illustrates a modification of an actuator in accordance with example embodiments.

### DETAILED DESCRIPTION

Example embodiments will now be described more fully with reference to the accompanying drawings. Example embodiments are not intended to limit the invention since the invention may be embodied in different forms. Rather, example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments are directed to an actuator. In example embodiments the actuator may be used to actuate a valve. In example embodiments, the actuator may be used as an emergency shut off mechanism

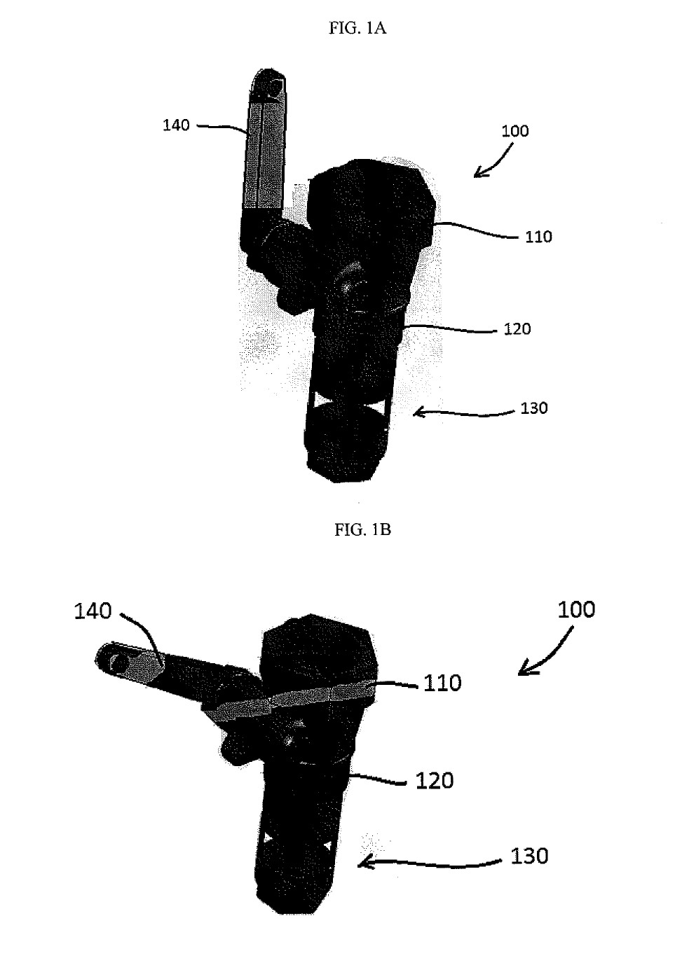

FIGS. 1A and 1B are views of a valve 100 in accordance with example embodiments. In example embodiments, the valve 100 may be related to a safety system, however, the invention is not intended to be limited thereto. In example embodiments, the valve 100 may include a body with threads 120 as shown in FIGS. 1A and 1B. Thus, in example embodiments, the valve 100 may be attached to a, for example, a tank, by interfacing the valve 100 with complementary threads that may be in the structure. Although FIG. 1 illustrates the valve 100 as having threads 120, this is not intended to limit the invention since the threads 120 may be omitted from the valve 100 and the valve 100 may be attached to the external structure by another mechanism, such as, but not limited to, clamps, bolts, or some other means of attachment.

In example embodiments, the valve body may include a plurality of holes 130 at one end of the valve 100. In example embodiments, the plurality of holes 130 may be configured to allow a fluid, for example, air, gasoline, ethanol, or diesel fuel, to flow through the valve 100. Although FIG. 1 illustrates the plurality of holes 130 as comprising four substantially rectangular holes, example embodiments are not limited thereto as the number of holes may be greater than or less than four, and the shape of the holes may be a shape different from a rectangle. For example, in example embodiments, the plurality of holes 130 may be, but is not limited to, circular holes, triangular holes, square holes, hexagonal holes, or octagonal holes.

In example embodiments, an end of the valve 100 may include a flange 110 which may be configured to break away under a predetermined load. In this case, if the flange 110 were to break away, the valve 100 is further configured to automatically shut off. Thus, in example embodiments, the valve 100 may be closed in the event of an accident which results in the valve flange 110 being broken.

In example embodiments, the valve 100 may further include an arm 140 configured to control the valve 100. For example, as shown in FIG. 1A, the arm 140 may be oriented in a first position to open the valve 100 and to allow fluid to flow therethrough. To close the valve, the arm 140 may be rotated to a second position as shown in FIG. 1B. Thus, in the second position, fluid may be prevented from flowing through the valve 100.

In example embodiments, the valve 100 may be configured so the arm 140 is biased towards the closed position (FIG. 1B). Thus, unless a force is applied to the arm 140, the arm 140 will be in the second position 140 or move to the second position. Of course, it is understood the arm 140 may be rotated to the open position (FIG. 1A) provided the appropriate force is applied thereto. If the force is removed, however, the arm 140 will rotate back in the closed position.

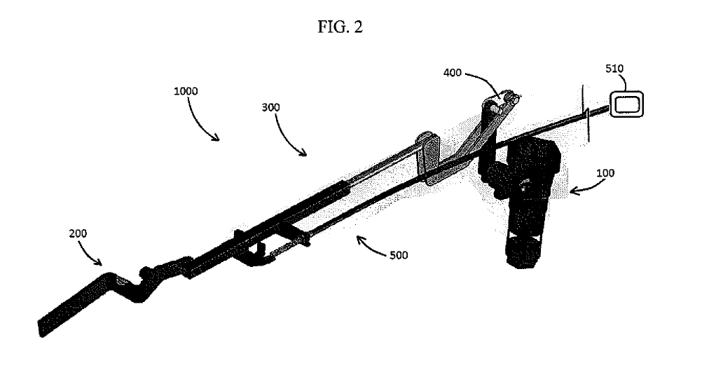

In example embodiments, an actuator 1000, as shown in FIG. 2, may be coupled to the arm 140 of the valve 100 to operate the valve 100. As shown in FIG. 2, the actuator 1000 may include a handle 200 connected to a telescoping assembly 300 which, in turn, may be coupled to the arm 140 of the valve 100 by a link 400. As will be explained, a rotation of the handle 200 may cause the arm 140 of the valve 100 to rotate. Although example embodiments illustrate the actuator 1000 as being configured to rotate an arm of a valve, the invention is not limited thereto as the actuator 1000 may be applied to actuate other devices.

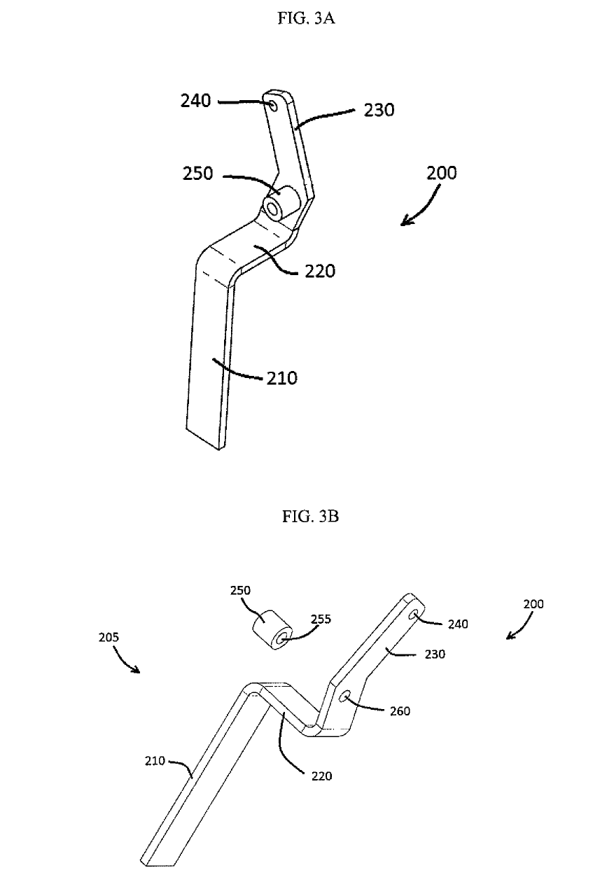

FIG. 3A is a view of the handle 200 in accordance with example embodiments and FIG. 3B is an exploded view of the handle 200. As shown in FIGS. 3A and 3B, the handle 200 may be comprised of a main member 205 and a bushing 250. In example embodiments, the main member 205 may resemble a Z shaped structure having a grasping portion 210, a joining portion 220, and a driving portion 230. In example embodiments, the grasping portion 210 may be configured so the handle 200 may be easily grasped by the human hand. Thus, in example embodiments, the grasping portion 210 may resemble a plate which may be about, but is not limited to, a plate having a width of about one inch and a length of about six inches.

In example embodiments, the handle 200 may include a first hole 260 arranged near a middle thereof and a second hole 240 arranged at an end of the driving portion 230. In example embodiments, the first hole 260 may mark a location about which the handle 200 may pivot. For example, in example, embodiments a fastening structure, such as a bolt or a pin, may be inserted into the first hole 260 and into a supporting structure. Thus, in example embodiments, the handle 200 of the actuator may rotate about a line passing through the first hole 260.

In example embodiments, the bushing 250 may resemble a short cylinder having a hole 255 which may be about the same size as the first hole 260 of the handle 200. In example embodiments, the bushing 250 may be arranged so that the hole 255 of the bushing 250 and the first hole 260 of the handle 200 are aligned. In this configuration, the bushing 250 may be attached to the driving portion 230 of the handle 200 by a conventional means, such as, but not limited to, welding.

Although the handle 200 is illustrated as being comprised of two pieces (the main member 205 and the bushing 250), example embodiments are not limited thereto. For example, the handle 200 may be fabricated from a casting process that results in a single unitary structure having substantially the same geometry as the combined main member 205 and the bushing 250. Furthermore, it is emphasized that the example handle 200 illustrated in the figures if for the purpose of illustration only since the handle may be modified. For example, in the figures, the main member 205 is illustrated as being comprised of a Z shaped structure, however, the handle 200 of example embodiments is not limited to a Z shaped structure as the structure of the handle 200 may have another shape such as a substantially planer shape. Thus, it is understood that the shape of the handle 200 is for purposes of illustration only and is not intended to limit the invention.

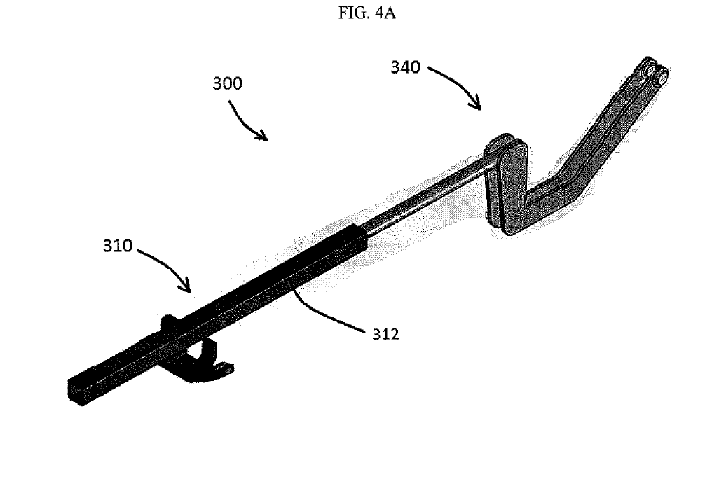

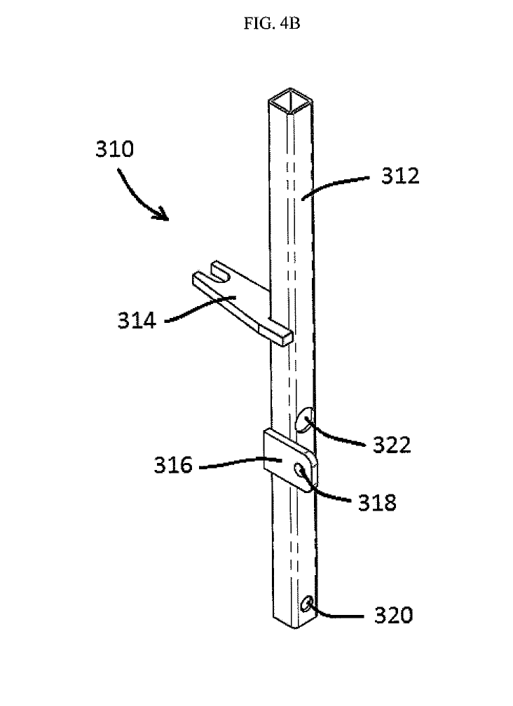

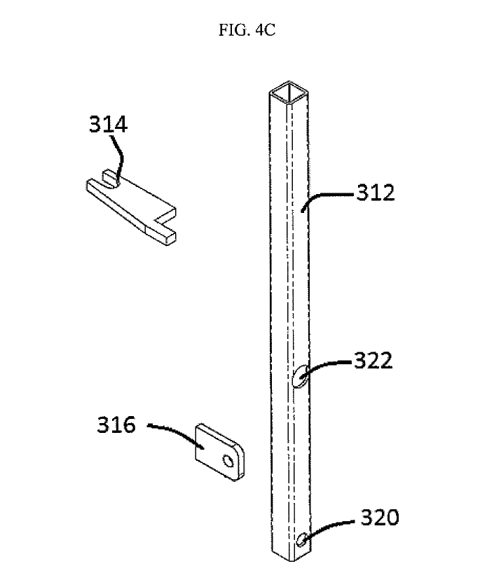

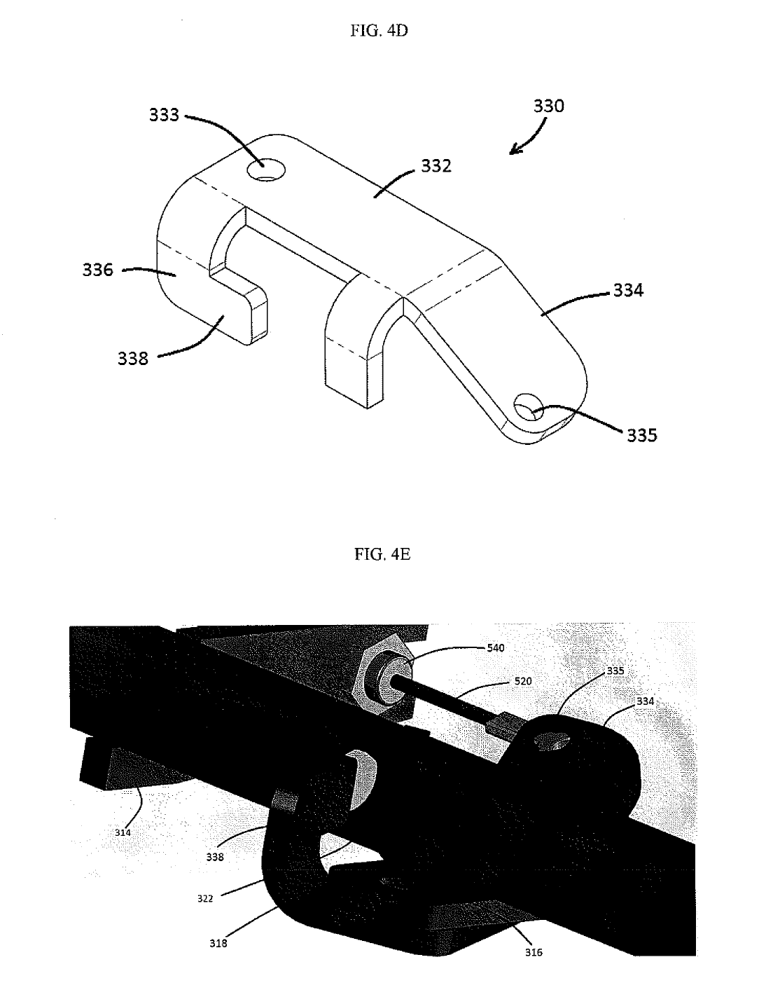

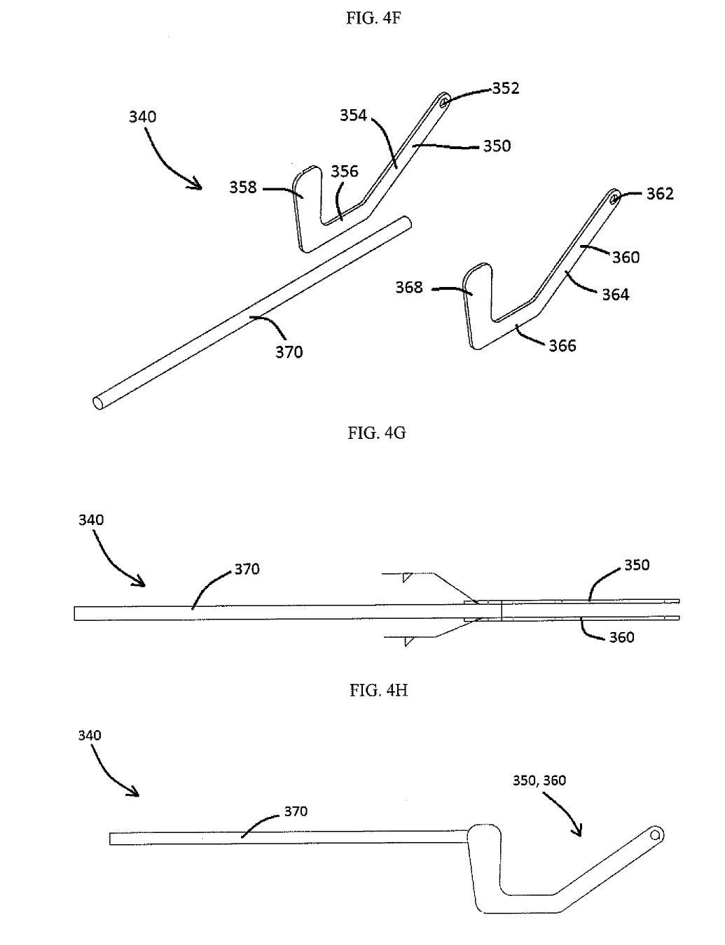

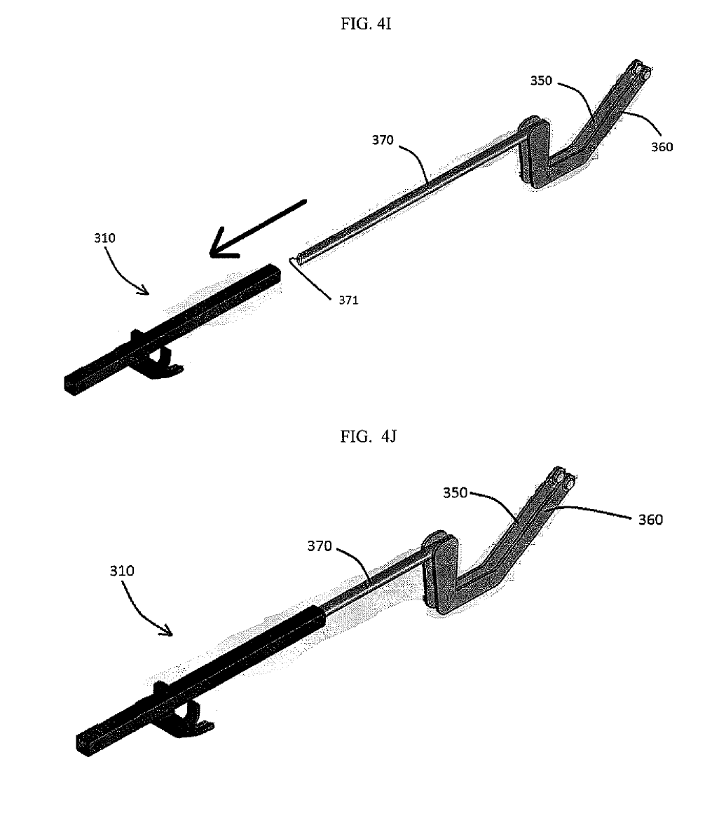

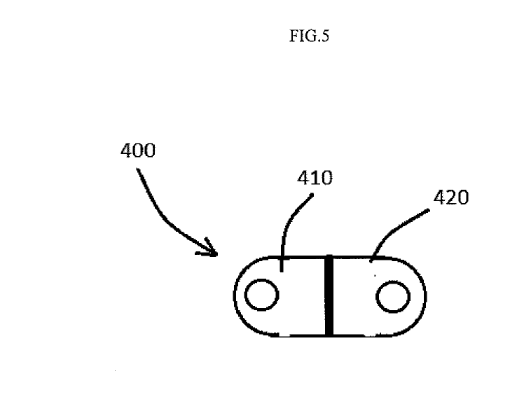

FIG. 4A is a view of the telescoping assembly 300 in accordance with example embodiments. As shown in at least FIG. 4A, the telescoping assembly 300 may include a sleeve 310 in which a sliding member 340 may slide. In example embodiments, the sleeve 310 may have a body 312 that resembles a substantially square tube, however, example embodiments are not limited thereto as the body 312 may have another shape such as, but not limited to, a tube having an annular cross section, a rectangular cross section, a triangular cross section, a hexagonal cross, section, or an octagonal cross section. In addition, the body 312 is not required to be a closed shape since the body 312 may have another shape such as, but not limited to, a C-shape, a U-shape, or a V-shape.

Referring to FIGS. 4B and 4C (which is an exploded view of the sleeve), the body 312 may have a first hole 320 arranged at an end thereof. In example embodiments, the first hole 320 of the body 312 may be aligned with the second hole 240 of the handle 200 and a pin (not shown) may be inserted into the first hole 320 and the second hole 240 to rotatably attach the handle 200 to the telescoping assembly 300.

In example embodiments, the sleeve 310 may further include a first tab 316 attached to the body 312. The first tab 316 may be attached to the body 312 by a conventional means such as welding, but may be attached via another means such as gluing or with screws, clamps, or pins. In example embodiments, the first tab 316 may resemble a substantially flat plate having a hole 318 therein which may be used to facilitate a connection between the first tab 316 and a platform 330 (see FIG. 4D, to be described later). In example embodiments, the sleeve 310 may further include a second tab 314 which may be configured to attach to the body 312 by a means such as, but not limited to, welding but may also be attached by another means such as, but not limited to, gluing or with screws, clamps, or pins. In example embodiments, the second tab 314 may be used to secure a trip wire 500 (see at least FIG. 2, to be described later) to the telescoping assembly 300.

In example embodiments, the body 312 may include a second hole 322. The second hole may be configured to allow a stop 338 of the platform 300 (see FIG. 4E) to insert into the body 312. In example embodiments, the stop 338 may prevent the sliding member 340 from sliding along the sleeve 310.

FIG. 4D is a view of the platform 330 in accordance with example embodiments. In example embodiments, the platform 330 may be rotatably attached to the sleeve 310. For example, in example embodiments, the platform 330 may include a substantially flat base 332 with a hole 333 therein. In example embodiments, the hole 333 may be aligned with the hole 318 of the first tab 316 and a pin (not shown) may be inserted through the hole 318 and the hole 333 to rotatably attach the platform 330 to the first tab 316. In this manner, the platform 330 may rotate with respect to the body 312 of the sleeve 310.

FIG. 4E is a view of the platform 330 attached to the first tab 316 (with the pin not shown). As shown in FIG. 4E, the stop 338 is arranged so as to rotate into and out of the second hole 322 of the body 312. In example embodiments, when the stop 338 is rotated into the second hole 322, the stop 338 may prevent the sliding member 340 from sliding down the body 312 of the sleeve 310.

FIG. 4F is an exploded view of the sliding member 340 in accordance with example embodiments and FIGS. 4G and 4H are a top and a side view of the sliding member 340 in accordance with example embodiments. As shown in FIGS. 4F-4H, the sliding member 340 may be comprised of a rod 370, a first side plate 350, and a second side plate 360. The rod 370 may have a circular cross section and the circular cross section may have a diameter small enough to allow the rod 370 to slide within the body 312 of the sleeve 310. Example embodiments, however, are not limited thereto as the cross section of the rod 370 may have another shape such as, but not limited to, a square shape, a rectangular shape, an elliptical shape, or an octagonal shape.

In example embodiments, the first and second side plates 350 and 360 may be rigidly attached to the rod 370 by a means such as, but not limited to, welding as indicated in FIG. 4G. Thus, the rod 370 and the side plates 350 and 360 may act as a rigid body. Example embodiments is not limited by the attachment means as the rod 370, the first side plate 350 and the second side plate 360 may be connected to one another by another means such as, but not limited to, brackets, pins, and screws.

For a purpose described later, in example embodiments, the first and second side plates 350 and 360 may be substantially identical and each may have a J shape. For example, as shown in FIGS. 4F-4H, the first side plate 350 may have a first region 354, a second region 356, and a third region 358, each of which may each resemble rectangular plates, arranged to form a J. Similarly, the second side plate 360 may include a first region 364, a second region 366, and a third region 368 each of which may each resemble rectangular plates, arranged to form a J.

In example embodiments, the first region 354 of the first side plate 350 may include a first hole 352 arranged near an end thereof. Similarly, the first region 364 of the second side plate 360 may include a second hole 362 arranged near an end thereof. In example embodiments, the first and second holes 352 and 362 may be substantially aligned with each other so that a pin may pass through each of the first and second holes 352 and 362. In example embodiments, the diameters of the first and second holes 352 and 362 may be substantially the same. These aspects of example embodiments are not intended to limit the invention since the holes may have different diameters and may be offset from one another. Furthermore, it is not required that the first and second side plates 350 and 360 have the first and second holes 352 and 362 since, rather than passing a pin through each of the first and second holes 352 and 362, a short cylindrical bar may be welded between first and second side plates 350 and 360 in a region corresponding to where the pin would be placed. On additional note, although the sliding member 340 has been described as being comprised of two side plates 350 and 360 as being welded to the rod 370, the invention is not limited thereto. For example, in example embodiments, the sliding member 340 may be fabricated via a casting process to produce a structure substantially identical to the sliding member 340 illustrated in the figures. Additionally, various features of example embodiments are not meant to limit the invention. For example, although the first and second side plates 350 and 360 are illustrated and described as being J-shaped, example embodiments are not limited thereto as the first and second side plates 350 and 360 may have a different shape, for example, an L-shape or an arc shape.

FIG. 4I illustrates an example of the sliding member 340 and the sleeve 310 separated from one another. As shown in FIGS. 4I and 4J, the rod 370 of the sliding member 340 may be inserted into the body 312 of the sleeve 310. In example embodiments, an end 371 of the rod 370, however, would but up against the stop 338 when the stop 338 is rotated into the body 312. Thus, the stop 338 defines a point at which the rod 370 is prevented from moving further down the body 312. If the stop 338, however, is rotated out of the body 312, the rod 370 may travel further along the length of the body 312 of the sleeve 310.

FIG. 5 is a view of a link 400 in accordance with example embodiments. In FIG. 5, the link 400 is illustrated as a plate shaped body having a first hole 410 and a second hole 420. In example embodiments, the link 400 may be fabricated by bonding two steel members together with a metal having a relatively low melting point, for example, lead. In FIG. 5, the low melting point metal is illustrated as a relatively thick black line running down the middle of the link 400. Thus, in example embodiments, the link 400 may act as a mechanical fuse allowing ends of the link to separate if the link 400 is exposed to a relatively high temperature (for example, 200 F). Example embodiments are not limited to using the link 400 described above. For example, the entire link 400 may be made of a metal having a predetermined and relatively low melting point. In addition, the link 400 is not required to be made of metal since other suitable materials are available. In example embodiments, the link 400 may be configured so that the link “breaks” at about 200 F. As shown in FIG. 2, the link 400 may be used to attach the actuator 1000 to the arm 140 of the valve 100.

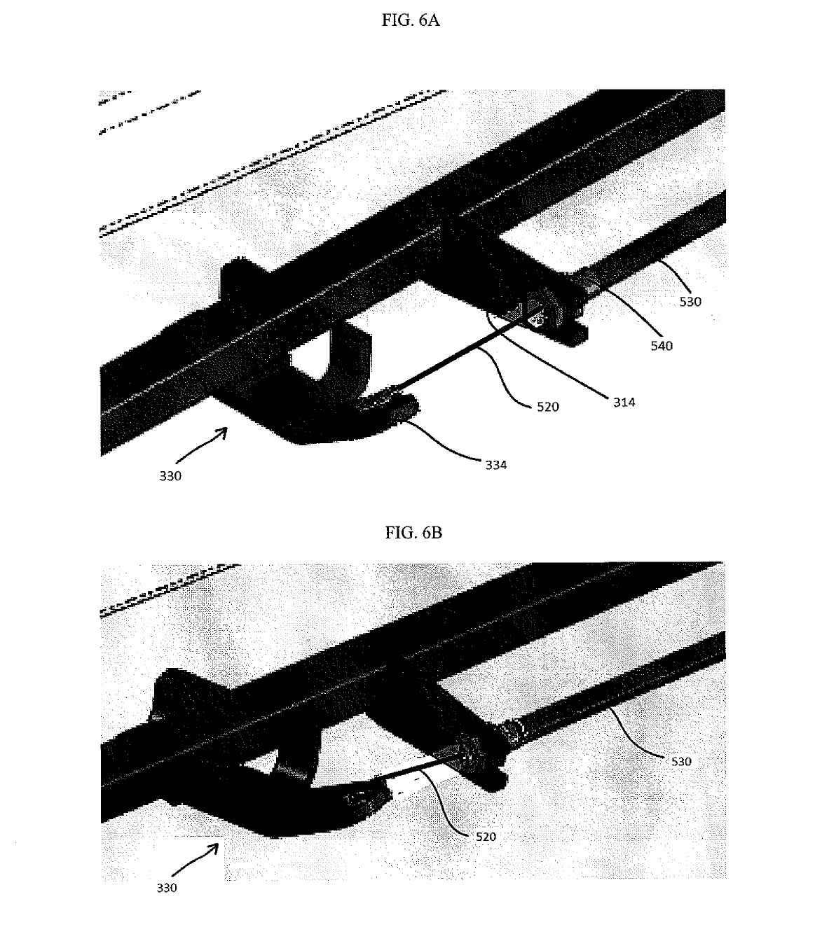

In example embodiments, the actuator 1000 may further include a trip wire 500 as shown in at least FIG. 2. In example embodiments, the trip wire 500 may be comprised of wire 520 threaded through a tube 530 (see FIGS. 6A-6B) that is connected to the second tab 314 of the sleeve 310 by a lock nut 540. One end of the wire 520 may be connected to a handle 510 (see FIG. 2) and another end of the wire 520 may be connected to the platform 330.

FIGS. 6A and 6B are close up views showing the wire 520 connected to the platform 330. In example embodiments, the wire 520 may be connected to the platform 330 by a conventional means such as welding and/or using nuts, bolts, and pins. FIG. 6A illustrates the platform 330 in a first position (where the stop 338 is inserted into the body 312 of the sleeve 310) and FIG. 6B illustrates the platform 330 in a second position (where the stop 338 is rotated out of the body 312 of the sleeve 310). In example embodiments, the platform 330 may be rotated from the first position to the second position when an operator pulls on the handle 510. Pulling on the handle 510 creates tension in the wire 520 which causes the wire 520 to pull on the platform 330 to cause the platform to rotate to the second position.

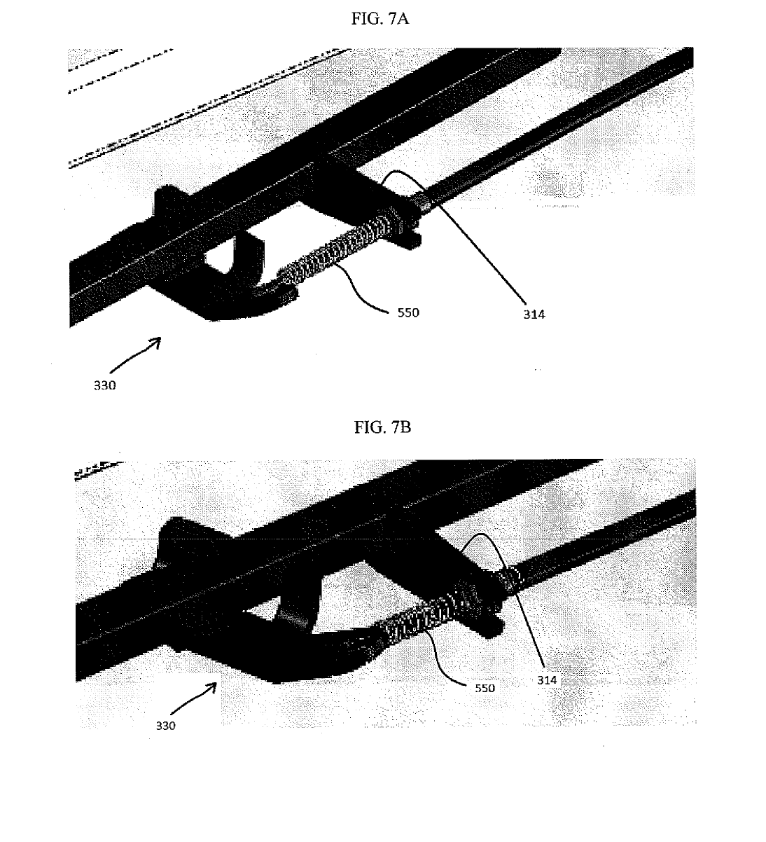

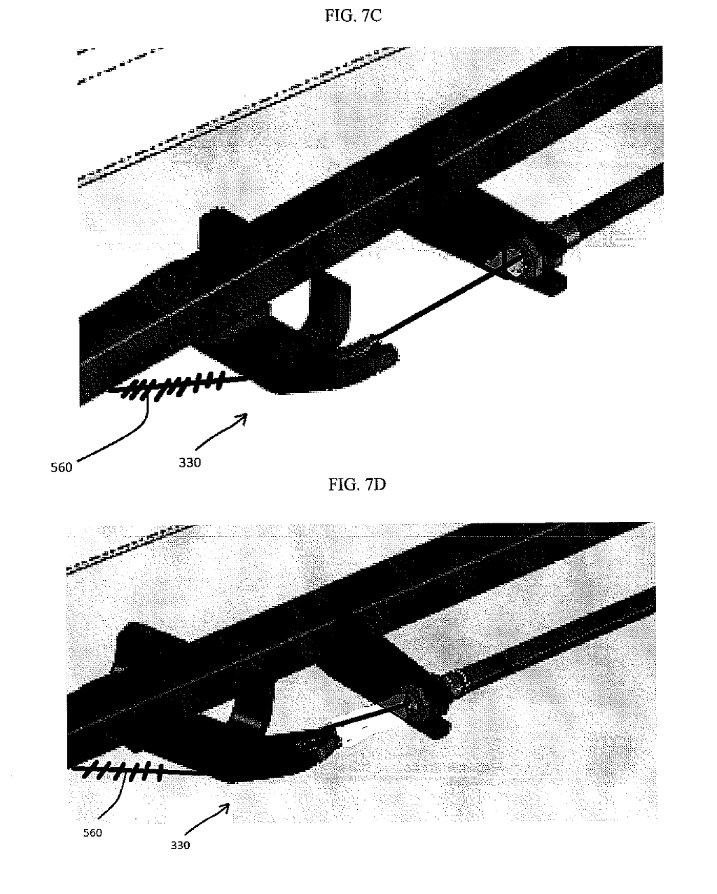

FIGS. 7A and 7B illustrate a biasing member 550 that is incorporated into the actuator 1000. In example embodiments, the biasing member 550 may be configured to rotate the platform 330 back to its first position after an operator releases the handle 510. In example embodiments, the biasing member 550, for example, may be a coil spring arranged between the second tab 314 of the sleeve 300 and the platform 330. As shown in FIGS. 7A and 7B, as the platform is rotated from the first position (FIG. 7A) to the second position (FIG. 7B), the biasing member 550 is compressed. Thus, when the operator releases the handle 510, the compressed biasing member 550 may apply a force to the platform 330 to rotate the platform 330 back to the first position. Example embodiments, however, are not intended to be limited by a coil spring wrapped around the wire 520. For example, as shown in FIG. 7C, the biasing member may be a pre-tensioned spring 560 attached to each of the body 312 and the platform 330. As shown in FIG. 7D, the spring 560 stretches as the platform 330 is rotated to the second position under the force of the tension in the wire 520 due to an operator pulling on the handle 510. As the handle 510 is released, however, the tension of the wire 520 reduces and the spring 560 may rotate the platform 330 back to the first position under the influence of the tensile forces of the spring 560.

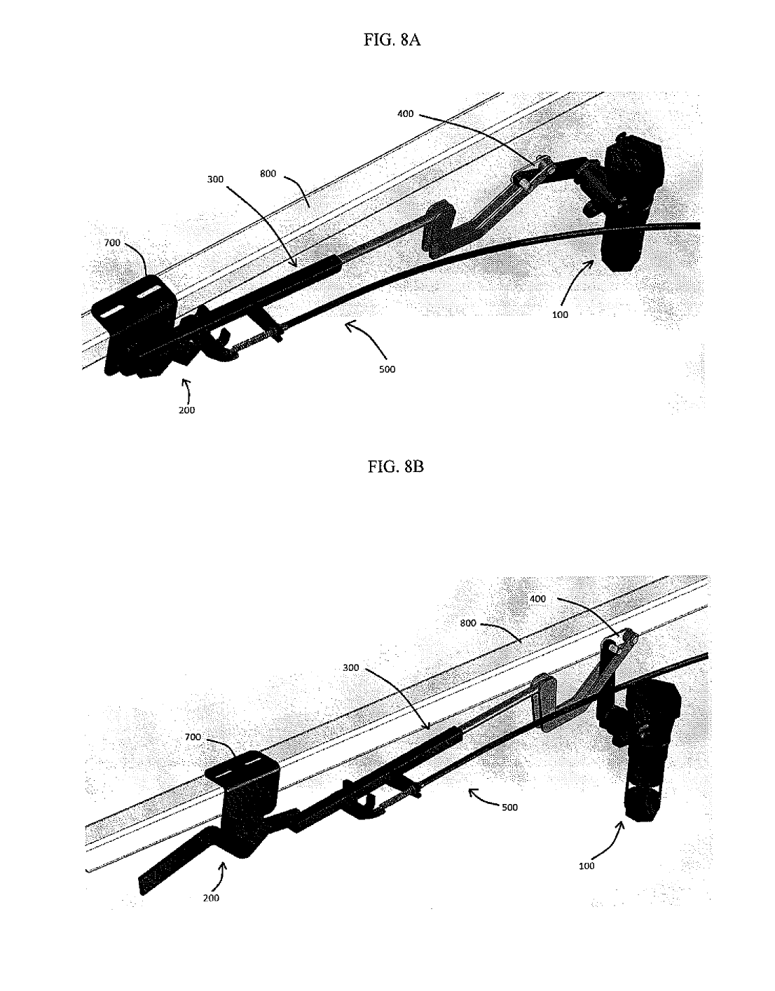

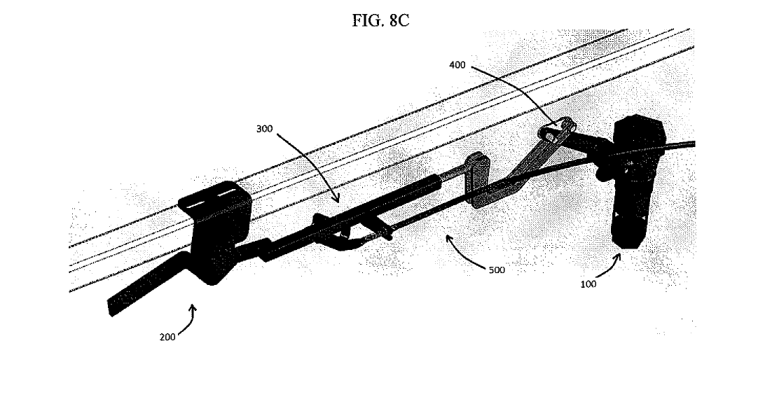

FIGS. 8A-8C illustrate the kinematics of the actuator 1000 actuating the valve 100 in accordance with example embodiments. Referring to FIG. 8A, the actuator 1000 is connected to a structural member 800. The structural member 800, for example, may be a structural tube, however, example embodiments are not limited thereto as the structure may be any structure including a plate or a beam such as an I-beam, a C-beam, or an H beam. In example embodiments, the actuator 1000 may be attached to the structure 800 by a bracket 700.

FIG. 8A illustrates the valve 100 being in a closed position. In this configuration, the platform 330 is arranged so that the stop 338 is inserted into the body 312 of the sleeve 310 such that an end 371 (see FIG. 4I) of the rod 370 of the sliding member 340 bears up against the stop 338. In addition, as is illustrated in FIG. 8A, the sliding member 340 is connected to the arm 140 of the valve 100 via the link 400, which may be configured as a mechanical fuse. In example embodiments, a user may grasp the handle 200 and rotate the handle 200 to the configuration of FIG. 8B. In doing so, the handle 200 exerts a force on the body 312 of the sleeve 310 thereby moving the body 312 towards the valve 100. Because the stop 338 is behind the rod 370, the stop 338 exerts a force on the rod 370 pushing the rod 370 towards the valve 100. The force from the rod 370 travels through the sliding member 340 to the link 400 which pulls on the arm 140 to open the valve as shown in FIG. 8B. To close the valve, the operator simply rotates the handle 200 to its original position (FIG. 8A) and the valve arm 140, under its own biasing force, rotates back to the closed configuration. Thus, in example embodiments, the actuator 1000 may be used to open and close the valve 100.

In example embodiments, the actuator 1000 may be configured to self lock when the handle 200 is rotated from the closed position (FIG. 8A) to the open configuration (FIG. 8B). For example, as shown in FIGS. 8B and 8C, the actuator 1000 may be configured so the hole 240 (serving as a pivot point between the handle 200 and the telescoping assembly 300) is below a line that passes through the hole 260 of the handle 200 (the pivot point of the handle 200) and the holes 352 and 362 of the telescoping assembly 300. In this way, the actuator 1000 may keep the valve 100 open without the use of a latch (or other device) that may be necessary to prevent the handle 200 from moving back to the closed position.

In example embodiments, the trip wire 500 offers an alternative means of closing the valve 100. Such a means may be useful if the operator is not near the handle 200 and the operator is required to shut the valve 100 off quickly. In this case, if the valve 100 is in the open position (FIG. 8B) due to the handle 200 being rotated to the second configuration (FIG. 8B), pulling the handle 510 (FIG. 2) of the trip wire 500 causes the platform 330 to rotate causing the stop 338 to rotate out of the body 312. In this state, the stop 338 no longer applies a force to the rod 370 and no longer prevents the rod 370 from sliding further into the body 312 of the sleeve 310. Accordingly, the sliding member 340 no longer applies a force to the link 400 which therefore applies no force to the arm 140 to keep the arm 140 in the open configuration. Accordingly, when the handle 510 is pulled, the valve 100 closes. While the valve closes, the rod 370 of the sliding member 340 is pushed further into the body 312 of the sleeve 310 as shown in FIG. 8C.

FIG. 8C represents an example of the actuator 1000 in a “tripped” configuration. In the tripped configuration, the stop 338 of the platform 330 is not behind the end 371 of the rod 370, but instead, is arranged along a side of the rod 370. In example embodiments, the stop 338 may be repositioned behind the end of the rod 370 by rotating the handle 200 back to the closed position (FIG. 8A). In doing so, the body 312 of the sleeve 310 is pulled back while the sliding member 340 remains stationary. In example embodiments, rotating the handle 200 pulls the body 312 back far enough to allow the stop 338 to rotate back into the hole 322 of the body 312 and behind the end 371 of the rod 370. Thus, in example embodiments, in the event the actuator 1000 assumes the “tripped” configuration as shown in FIG. 8C, the actuator 1000 may be “reset” by simply rotating the handle 200 back to the closed position as shown in FIG. 8A.

In example embodiments, the mechanical fuse 400 offers an additional means for allowing the valve to close. In example embodiments, if the valve 100 is in the open configuration (FIG. 8B) and the environment of the valve 100 exceeds a predetermined temperature, the mechanical fuse 400 may break allowing the valve 100 to close.

In example embodiments, the actuator 1000 may be used for several purposes. For example, the actuator 1000 may be incorporated into a fuel trailer to provide an actuating mechanism for a valve as well an emergency shut off for the valve. For example, the valve 100 of example embodiments may be associated with a fuel tank of a fuel trailer. In example embodiments, the handle 200 may be arranged at a first location of the fuel trailer while the handle 510 of the trip wire 500 may be arranged at a second location of the fuel trailer (which may be remote from the first location). In example embodiments, an operator may open the valve 100 as described above by rotating the handle 200. If the operator walked to an area around the trailer near the handle 510, the operator may be able to shut off the valve 100 by simply pulling the handle 510 rather than having to return to the handle 200 to close the valve 100. Since time may be very critical in controlling a flow of fluid flowing through the valve 100, the actuator 1000 of example embodiments may reduce, minimize, or eliminate a potential disaster associated with spilled fuel.

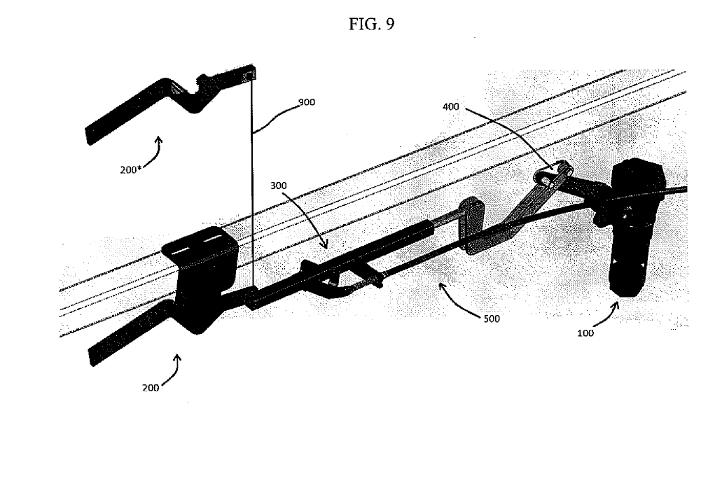

In example embodiments, the actuator 1000 may be modified for additional functionality. For example, as shown in FIG. 9, the actuator 1000 may be coupled to a second handle 200* by a coupling device 900, such as, but not limited to, a push-pull cable or a linkage. Such a modification may allow an operator to adapt the actuator 1000 for use in various types of equipment. For example, the actuator 1000 may be used in a fuel trailer having an emergency valve on a bottom side thereof. In example embodiments, the emergency valve may correspond to the valve 100 of example embodiments and thus may be actuated by an actuator similar to the actuator 1000. In this nonlimiting example embodiment, a push pull cable (an example of the coupling device) may run to a top of the trailer where the second handle 200* may be attached. The second handle 200* may allow for the emergency valve to be operated from a location remote from the actuator 1000. This would prevent the need for an operator to reach under the a trailer to open/close an emergency valve when the emergency valve is located thereunder.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. An actuator comprising:
a handle;
a telescoping assembly connected to the handle, the telescoping assembly including a sleeve, a sliding member configured to move along the sleeve, and a movable stop, wherein, in a first position, the movable stop is configured to prevent the sliding member from moving beyond a first point in the sleeve and, in a second position, allows the sliding member to move beyond the first point in the sleeve; and
a cable attached to the telescoping assembly, the cable being configured to operatively move the movable stop.

2. The actuator of claim 1, further comprising:
a biasing member, wherein the telescoping member further includes a platform rotatably connected to the sleeve and the biasing member biases the platform so the movable stop is in the first position.

3. The actuator of claim 2, wherein the biasing member is a coil spring surrounding a portion of the cable.

4. The actuator of claim 2, wherein the biasing member extends from the platform to the sleeve.

5. The actuator of claim 1, further comprising:
a connecting member configured to connect the telescoping assembly to a structure.

6. The actuator of claim 5, wherein the connecting member is a fuse link.

7. The actuator of claim 1, wherein the sleeve includes a support tab attaching the cable to the telescoping assembly.

8. The actuator of claim 1, wherein the telescoping assembly further includes a platform rotatably connected to the sleeve and the movable stop in moved by rotation of the platform.

9. The actuator of claim 8, wherein the cable is connected to the platform and is configured to rotate the platform.

10. The actuator of claim 9, further comprising:
a biasing member configured to bias the platform so that the movable stop is in the first position.

11. A fuel trailer comprising:
the actuator according to claim 1.
